(19) United States
(12) Patent Application Publication
(10) Pub. No.: US 2008/0080543 A1
(43) Pub. Date: Apr. 3, 2008

(54) NETWORK SWITCH WITH CONTROLLER I/O CAPABILITY

(75) Inventors: Stephen L. Hickox, Middlefield, OH (US); Jessica E. Forguites, Willoughby Hills, OH (US)

Correspondence Address: ROCKWELL AUTOMATION, INC./(AT), ATTENTION: SUSAN M. DONAHUE, E-7F19, 1201 SOUTH SECOND STREET, MILWAUKEE, WI, 53204, US

(73) Assignee: ROCKWELL AUTOMATION TECHNOLOGIES, INC., Mayfield Heights, OH (US)

(21) Appl. No.: 11/862,909

(22) Filed: Sep. 27, 2007

Related U.S. Application Data
(63) Continuation-in-part of application No. 11/536,334, filed on Sep. 28, 2006.

(51) Int. Cl. H04L 12/56

(52) U.S. Cl. 370/419

(57) ABSTRACT

A network component for an industrial automation system is provided. This includes a network switch that provides one or more ports such as for communicating with public or private network components. An interface component enables the ports to function as inputs or outputs to a controller.

### CROSS REFERENCE TO RELATED APPLICATION

This application is a continuation in part of U.S. patent application Ser. No. 11,536,334 filed on Sep. 28, 2006, entitled “INDUSTRIAL PROTOCOL AND GATEWAY” the entirety of which is incorporated herein by reference.

### TECHNICAL FIELD

The subject invention relates generally to industrial control systems and more particularly to a network switch that can be communicated with and controlled via input/output functions of a programmable logic controller.

### BACKGROUND

Control systems integrators and designers face many challenges—both before and after a system is designed or installed. Such systems typically include programmable logic controllers, communications modules, I/O modules, network components, machines, devices, and so forth that all have to cooperate to form a particular control systems solution. Initially, massive amounts of design and testing are involved before a given system is deemed operational. Such design includes both hardware functional testing and more prevalent includes testing of a vast amount of software including ladder logic, network software, human machine interface software, and so forth. Although it can be burdensome to initially get a system up and running, increasingly keeping the system operational at reasonable costs may even be more challenging than the original design and installation phase was in the first place.

As witnessed in recent years, control systems solutions have been provided in practically every geographical region of the world, where some systems are installed in extremely harsh and difficult to reach environments. If some issue were to arise with an installed system at one of these remote locations, one solution would be to send an engineer to such location to deal with the respective issue. As can be appreciated, this strategy could be quite expensive depending on how difficult it was to reach the remote location.

A less expensive solution than having onsite access to systems is to provide some form of remote access to systems. This usually included providing communications capabilities in the control system, where engineers could then remote into the system and potentially solve problems. Early versions of these remote capabilities included using dial-up modems that received a phone connection on one end and provided at least one serial connection such as RS-232 on the other end. These solutions were often unsatisfactory however although they did alleviate some of the remote access problems. Generally, modems were purchased as off-the-shelf solutions and thus were very difficult to integrate with a control system that had different interface requirements from standard network interfaces.

As more sophisticated networks have become common place in the control environment, devices such as Ethernet switches and routers began to emerge that also facilitate remote access. One problem with these solutions is that most organizations are very reluctant to open their sensitive, private networks up to outside communications. Thus, achieving remote access to a control system through the private network of the organization was generally not feasible. Another problem with such switches and routers is they again provide an off-the-shelf network solution but are ill-equipped to seamlessly interface in a control environment. Finally, security for such devices can come in many forms including providing the ability to shut off a network port from a network address that was unauthorized to access such a port. Unfortunately, this decision to limit access was outside the domain of the control system and thus, does not provide the type of control to effectively manage control systems across remote networks.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Systems and methods are provided to facilitate remote network access to control systems, mitigate unauthorized network access to the control systems, and allow the control systems to manage network communications via I/O capabilities of the control systems. In one aspect, a network switch is provided that includes one or more network ports. An interface component on the network switch enables at least one of the ports to appear as an input or output connection to a programmable logic controller (PLC) (or module having I/O capability). For example, the interface component may function as an Ethernet adapter to the PLC that allows Ethernet communications between the switch and the PLC, yet the respective ports of the switch are accessed and controlled from simple I/O commands of the PLC. In this manner, interactions with the switch can be controlled by the PLC as opposed to relinquishing control to the switch which may not facilitate an optimal remote access solution.

To illustrate I/O capabilities of the network switch, inputs from a respective port may indicate that an unauthorized MAC ID of a device is attempting to access the switch and ultimately the network on which the controller resides. Depending on how the controller decides to handle the unauthorized MAC ID access, an output could be set in the controller's output table that effectively disables the port where the unauthorized access occurred. In another application, the controller may note that a device has attempted access but given the nature of the access, time of day, process condition, or other programmed condition, the controller may choose to ignore such access. This type of control is in sharp contrast to previous solutions where all decisions to enable or disable the switch resided on the switch. With PLC control of the switch provided by the interface component, remote access to the control system can be managed in a more effective manner. Also, by providing simple I/O interface capabilities on the switch, interfacing between external networks, the switch, and the respective controller system can be greatly simplified since complex networking interfaces associated with prior switch configurations no longer need to be considered by the control system.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a network switch for an industrial automation system.

FIG. 2 is a diagram illustrating an example network switch interface.

FIG. 3 is a diagram illustrating an example network switch.

FIG. 4 is a diagram illustrating an example configuration interface for a network switch.

FIG. 5 is a diagram illustrating example diagnostic aspects for a network switch.

FIG. 6 is a diagram illustrating an example alarm configuration interface.

FIG. 7 illustrates an example interface providing port configuration options.

FIG. 8 illustrates an example interface for MAC ID management.

FIG. 9 illustrates an example VLAN interface.

FIG. 10 illustrates an example Quality of Service interface.

FIG. 11 illustrates a network control process 1100 for an industrial automation system.

### DETAILED DESCRIPTION

Systems and methods are provided to facilitate remote interactions with industrial control systems while controlling external network access to such systems. In one aspect, a network component for an industrial automation system is provided. This includes a network switch that provides one or more ports such as for communicating with public or private network components over the Ethernet. An interface component enables the ports to function as inputs or outputs to a controller. The system includes modules to read the inputs or write to the outputs over the network, where such modules can include a programmable logic controller.

It is noted that as used in this application, terms such as “component,” “module,” “interface,” and the like are intended to refer to a computer-related entity, either hardware, a combination of hardware and software, software, or software in execution as applied to an automation system for industrial control. For example, a component may be, but is not limited to being, a process running on a processor, a processor, an object, an executable, a thread of execution, a program and a computer. By way of illustration, both an application running on a server and the server can be components. One or more components may reside within a process and/or thread of execution and a component may be localized on one computer and/or distributed between two or more computers, industrial controllers, and/or modules communicating therewith.

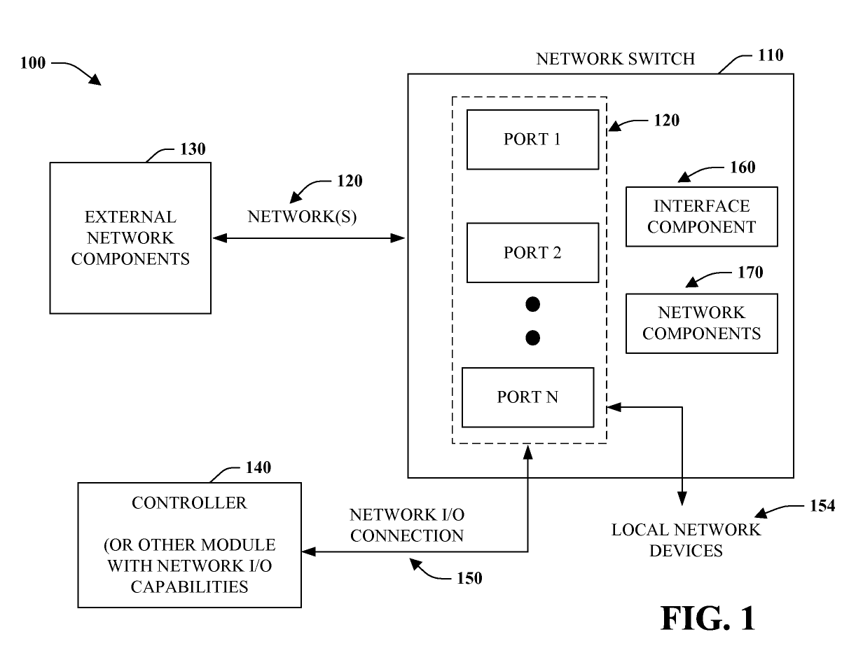

Referring initially to FIG. 1, a system 100 illustrates a network switch 110 for an industrial automation system. The network switch 110 includes one or more ports 120 that can be accessed across a network 124 from a plurality of external network components 120, where external implies outside the private network domain of a control system. A controller 140 employs a network I/O connection 150 in accordance with at least one of the ports 120 to control access of the network components 130 or other local network devices 154 to the control system. Access can be controlled by reading input status and controlling port access via input or output commands in the controller 140. An interface component 160 on the network switch 110 enables at least one of the ports 120 to appear as an input or output connection to the controller 140 such as a programmable logic controller (PLC). Thus, if the network switch has status to provide to the controller, such status can be reported in the controller's data table location representing other inputs to the controller. Similarly, the controller can turn on or off the network switch and associated ports by writing to a respective output location in the controller's data table. It is to be appreciated that substantially any device having network I/O capability can be employed in place of the controller 140 including communications modules or intelligent network modules, for example.

In one example, the interface component 160 may function as an adapter to the controller 140 providing suitable I/O protocols in conjunction with available network protocols that allows Ethernet communications (or other public domain network protocol) between the network switch 110 and the controller 140, yet the respective ports 120 of the switch are accessed and controlled from simple I/O commands of the controller. For example, an input can be read in a PLC data table location indicating status of the respective ports 120. Similarly, outputs can be set in the PLC data table that enable or disable operations of the ports 120. In this manner, interactions with the network switch 110 can be controlled by the controller 140 as opposed to relinquishing such control to the switch which may not facilitate an optimal remote access solution. As shown, the network switch 110 can include network components 170 or electronics that facilitate network connections between the external components 130, controller 140, and/or network devices 154.

To illustrate I/O capabilities of the network switch 110, inputs from a respective port 120 may indicate that an unauthorized MAC ID of an external network component 130 or local network device 154 is attempting to access the switch and ultimately the network on which the controller 140 resides. Depending on how the controller 140 processes the unauthorized MAC ID access, an output could be set in the controller's output table that effectively disables the port 120 where the unauthorized access occurred. In another application, the controller 140 may detect that a device has attempted access but given the nature of the access, time of day, process condition, or other programmed condition, the controller may ignore such access depending on logic programmed in the controller. This type of control is in sharp contrast to previous solutions where all decisions to enable or disable the switch 110 resided on the switch. With PLC control of the switch provided by the interface component 160 and I/O capability, remote access to the control system can be managed in a more effective manner. Also, by providing simple I/O interface capabilities on the network switch 110, interfacing between external networks 130, the switch 110, and the respective controller 140 can be greatly simplified since complex networking interfaces associated with prior switch configurations no longer need be interfaced by the control system.

As will be described in more detail below, the network switch 110 can provide a plurality of capabilities that facilitate remote network management of control systems. This includes enhanced diagnostic capabilities to aid in determining interactions with the control system, straight-forward and easy configuration screens for the switch, and other switch management interfaces. Other aspects include, persistent real-time data connections between the switch 110 and controller 140 which includes the ability to enable or disable the ports 120 using the real-time connection. Diagnostics are facilitated across such connections including the ability to receive alarms, unauthorized MAC ID status via the real-time connection, general health or condition of the switch, and the ability to configure the switch to permit MAC ID management. The network switch can be configured via a profile page in programming software, via a network program such as Telnet or other program, or configurable through a network protocol such as CIP™ via messaging commands. The switch 110 can be configured to reset its outputs during a controller fault, configured to hold last state, or configured to an idle state during controller faults. The switch 110 can be controlled and configured via CIP™ and can be set to learn network traffic thresholds where configurable alarms (e.g., on or off) exceeding such thresholds can be passed to the controller via data table inputs or other messages.

It is to be appreciated that the network switch 110 can function as a network infrastructure device supporting example functions such as switching capabilities, routing capabilities, network management capabilities, pass-thru capabilities, and so forth. Substantially any network infrastructure device that provides at least one input or at least one output to a controller can be supported. It is noted that such inputs or outputs to the controller can appear in the controllers data table memory where other inputs and outputs are processed such as analog or digital I/O. Data table is generally where a controller reads its inputs into memory and writes its outputs based on logic in the PLC program. Data tables can also include tag data storage locations and other memory locations such as timer, counter, and message locations.

Before proceeding, it is noted that the components 130 or 154 can include various computer or network components such as servers, clients, programmable logic controllers (PLCs), communications modules, mobile computers, wireless components, control components and so forth which are capable of interacting across the network 124. Similarly, the term PLC as used herein can include functionality that can be shared across multiple components, systems, and or networks 124 or 150. For example, one or more PLCs can communicate and cooperate with various network devices across the network 124 or connection 150. This can include substantially any type of control, communications module, computer, I/O device, sensor, Human Machine Interface (HMI)) that communicate via the network which includes control, automation, and/or public networks. The PLC can also communicate to and control various other devices such as Input/Output modules including Analog, Digital, Programmed/Intelligent I/O modules, other programmable controllers, communications modules, sensors, output devices, and the like.

The ports 120, and network connections 124, 150, 154, can include protocols for public networks such as the Internet, Intranets, and automation networks such as Common Industrial Protocol (CIP™) networks including DeviceNet and ControlNet. Other networks include Ethernet, DH/DH+, Remote I/O, Fieldbus, Fieldbus Foundation, Modbus, Profibus, Profinet, Modbus TCP, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

In addition to various hardware and/or software components, various interfaces can be provided to manipulate the switches 110 where various examples are illustrated in more detail below. This can include a Graphical User Interface (GUI) to interact with the switch 110 or other components including any type of application that sends, retrieves, processes, and/or manipulates data, receives, displays, formats, and/or communicates data, and/or facilitates operation of the system 100. For example, such interfaces can also be associated with an engine, server, client, editor tool or web browser although other type applications can be utilized.

The GUI can include a display having one or more display objects (not shown) for manipulating the switch 110 including such aspects as configurable icons, buttons, sliders, input boxes, selection options, menus, tabs and so forth having multiple configurable dimensions, shapes, colors, text, data and sounds to facilitate operations with the switch. In addition, the GUI can also include a plurality of other inputs or controls for adjusting and configuring one or more aspects. This can include receiving user commands from a mouse, keyboard, speech input, web site, remote web service or other device such as a camera or video input to affect or modify operations of the GUI.

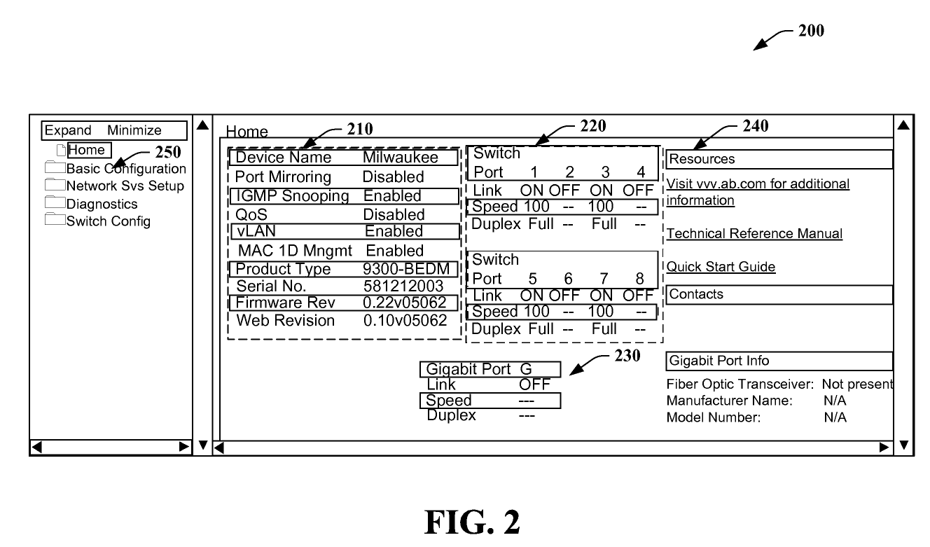

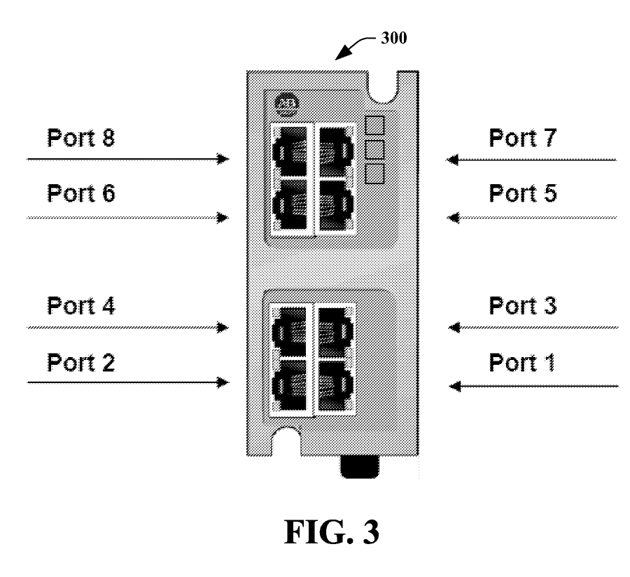

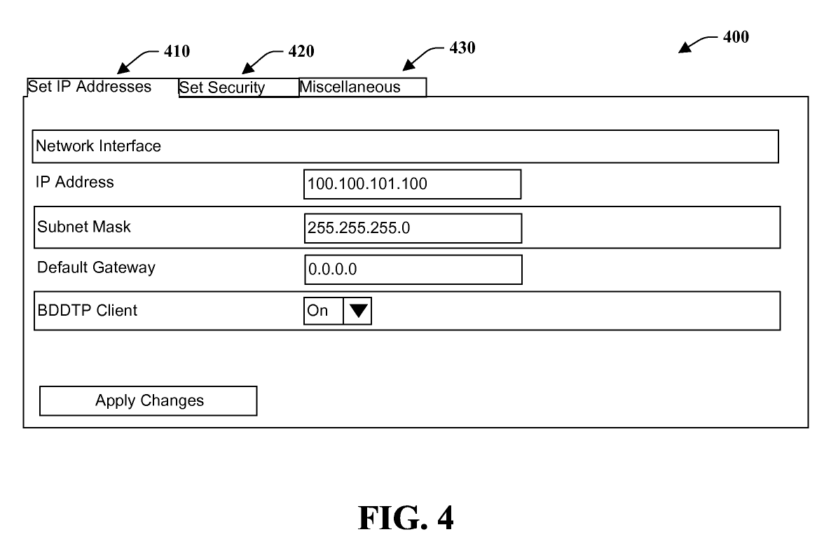

Referring now to FIG. 2, an example network switch interface 200 is illustrated. Before proceeding, it is noted that FIGS. 3 and 4 are described in conjunction with FIG. 2 and thus do not result in separate discussions for the respective figures. At 210 of FIG. 2, various configuration options are provided. These include:

A Device Name identifies the switch, and where possible values are user programmable. A Port Mirroring configuration allows possible values of Enabled or Disabled, where a Default Value is disabled. This feature allows traffic on one port, to be copied and sent (mirrored) to another port to enable an Ethernet sniffer to capture such data. Port Mirroring will be described in more detail below. Another selection at 210 includes a QoS field where possible Values are: Enabled or Disabled. When enabled, the switch can prioritize packet delivery to a certain port or MAC address. A VLAN filed at 210 includes possible configuration values of: Enabled or Disabled. VLAN (Virtual LAN) can be used to mitigate network traffic caused by Multicast and Broadcast Ethernet traffic. With this feature, the switch ports can be partitioned into different private domains.

Another configuration at 210 includes a MAC ID Management field where possible Values are: Enabled or Disabled. This field determines if a MAC ID is authorized on the network by checking the allowed MAC Ids, and notifies the PLC via an input field in the PLC when an unauthorized node appears on the network. A Product Type field includes the part number of the device. Other fields can include device serial number, firmware revision, and web revision for applicable interfaces.

Referring briefly to FIG. 3, an example switch configuration 300 is illustrated. As shown, the switch 300 includes eight network ports however more or less than eight can be provided. At 310, one or more status LED's can be provided on the switch 300. It is noted that the ports are marked 1 though 8 where even ports are on one side and odd port numbers on the other. It is to be appreciated that other port numberings are possible.

Referring back to FIG. 2, a section 220 on the interface 200 is employed for switch configurations relating to the switch depicted in FIG. 3. This includes three basic configuration options for each port including Link, Speed, and Duplex. Link includes possible Values of ON (Green LED flashing with data traffic), and OFF. On is if a device is connected to the port and has power. When the Port is shut off by the PLC, it can be shown in red. Speed: includes Possible Values: 10 (green LED), or 100 (orange LED).

Duplex includes Possible Values of Full or Half duplex. At 230 of FIG. 2, Gigabit port settings are provided. This is offered as an option to the unit and employs a pluggable SFP MSA compliant transceiver. A fiber optic transceiver can be used to connect to a fiber network backbone.

If a basic configuration option is selected at 250, an interface screen 400 is provided as shown in FIG. 4. At 410, a set IP address option is selected. This includes fields for setting an IP address, setting a subnet mask, default gateway settings, and Bootp selections. The switch can be configured with Bootp client enabled by default. To assign an address, place the switch on the on a network with a Bootp Server, and cycle power to the switch, where it can attempt to obtain an IP address several times from the server, before timing out and defaulting to an address: 192.168.1.1. As can be appreciated, other defaults can be provided.

At 420, a security tab can be provided for network security configurations. An administrator password is provided and can be changed before the switch is placed in service. The password is used for a Management Interface (HTTP session), telnet and ftp interface (used to upgrade firmware). The username is verified for the ftp session, where the username for the HTTP session is not checked (therefore can be anything). At 430, a miscellaneous selection allows for providing a device name that describes its location or connected devices. Other aspects include a user inactivity setting that allows users to change the length of time the Management Interface (HTTP session) remains open while inactive. Before proceeding, one or more of the following definitions can apply:

UDP—Defined by RFC 1122, section 4.1: The User Datagram Protocol offers a minimal transport service. UDP is used by applications that do not require the level of service of TCP or that desire to use communications services (e.g., multicast or broadcast delivery) not available from TCP. An application program running over UDP interacts directly with end-to-end communication problems that a connection-oriented protocol would have handled—e.g., retransmission for reliable delivery, packetization and reassembly, flow control, congestion avoidance, and so forth. This is commonly observed with I/O type devices that will send out information at an RPI rate.

TCP—Transmission Control Protocol, TCP enables two hosts to establish a connection and exchange streams of data. TCP guarantees delivery of data and also guarantees that packets will be delivered in the same order in which they were sent.

DNS—(Domain Name Server) Translates domain names into IP addresses, for example www.example.com may translate to 192.168.100.100

DHCP—(Dynamic Host Configuration Protocol) Commonly used on office networks. Scarce IP address space is efficiently used because IP addresses are “leased” to clients for a limited time. This lease concept facilitates the recycling of addresses, which is the heart of DHCP.

Bootp—(Bootstrap Protocol) Commonly used with AB Ethernet products, defined by RFC 951, BOOTP protocol is used by a client machine to locate its IP address and network mask.

Domain—A group of computers and devices on a network that are controlled as a unit with common rules and procedures

IGMP Definition—the switch can include a feature referred to as IGMP snooping. In one aspect, IGMP snooping can sort multicasting devices into groups. This can limit the multicast packets received by hosts that do not need the information, thus making the network more efficient and deterministic. Thus, IGMP can be used when I/O is running on the network and can help to isolate UDP traffic to ports that need to receive it. When it is not used, other devices may be slowed down by the continuous flow of UDP packets. IGMP can be configured by enabling it and setting a version and query period. The Query period determines how often a network is queried for Group information, the hosts on the network will respond with their group information. To observe multicast groups, an IGMP report can be generated and located under a “Diagnostics” folder interface.

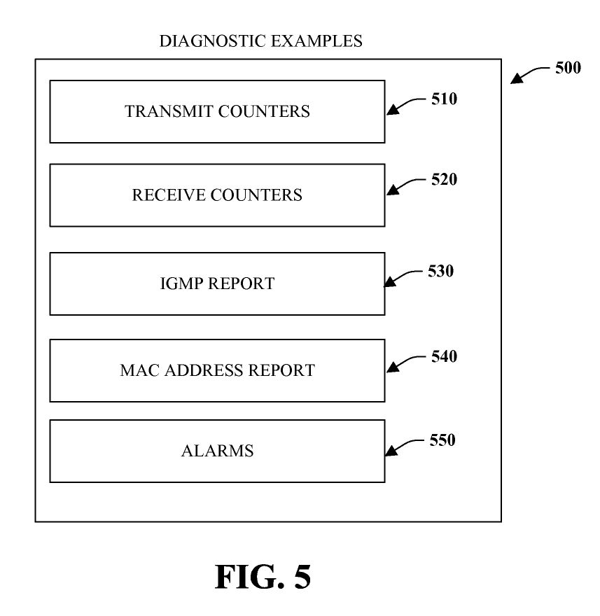

FIG. 5 illustrates various diagnostic aspects for a network switch. At 510, one or more transmit (TX) counters can be provided. TX counters include: Tx Octet Count—Total of transmitted good octets from the selected port; Tx Drop Pkts Count—Packet is not acknowledged by the receiving host; Tx BroadcastPkts Count—Number of good packets sent w/destination of end devices. Receivers are unspecified; Tx MulticastPkts Count—Packets sent to members of multicast group. One terminal to many hosts; Tx UnicastPkts Count—In contrast with multicast, consist of one terminal transmitting to one host; Tx Collisions Count—Two terminals transmit packets at the same time causing them to collide, Collision Count should be low, where collisions could indicate a faulty device on the network; Tx SingleCollision Count—Packet collides with one other terminal's transmitted packet; Tx MultipleCollision Count—Packet collides with more than one terminal's transmitted packets; Tx DeferredTransmit Count—Number of packets delayed because the network is busy (Higher the number the less deterministic the network); Tx LateCollision Count—Collision is detected later than the 512 bits into the packet transmittion, cable may be too long (100 meters 10/100baseT limit), repeating hubs on the network; Tx ExcessiveCollision Count—Packets not transmitted because the packet experienced 16 failed attempts, usually indicates bad cabling or connecters; Tx FrameInDisc Count—Network Device is not acting in compliance with a flow control request; Tx PausePkts Count—Pause frames sent by this port

At 520, one or more receive (RX) diagnostic counter can be provided. Receive counters include: Rx Octets—Total good octets received on selected port; Rx Undersize Pkts—Acceptable packets that are under 64 octets long; Rx Pause Pkts—Pause packets received by this port; Pkts64 Octets—Data packets=512 bits; Pkts65 to 127 Octets—Data packets=520-1016 bits; Pkts128 to 255 Octet—Data packets=1024-2040 bits; Pkts256 to 511 Octet—Data packets=2048-4088 bits; Pkts512 to 1023 Octet—Data packets=4096-8184 bits; Pkts1024 to 1522 Octet—Data packets=8192-12176 bits; RxOversize Pkts—Packets over 12176 bits or 1523-1536 Octets; RxJabbers Pkts—Packets longer than 1522 Octets, and have an error, usually caused by a faulty network adapter card on the network; RxAlignment Errors—Packets between 64 and 1522 octets, and have an error. Excessive alignment errors usually indicate a speed mismatch between the port and the connected device.

Other receiver diagnostics 520 include: RxFCS Errors—Packets received (between 64-1522 octets) with FCS (frame check sequence) not matching. Could be caused by a speed mismatch between the port and the connected device; RXGoodPkts—Octets received with no errors; RxDrop Pkts—Packets dropped due to lack of resources (bandwidth, input buffer); RxUnicast Pkts—Unicast packet received (1 receiving host); RxMulticast Pkts—Multicast packets received (many receiving hosts); RxBroadcast Pkts—Received by all hosts on the network; RxSAChanges—Number of times the Source address of a good packet has changed value. A count greater than 1 indicates a repeater based network; RxFragments—Packets received less than 64 octets that have an FCS or alignment error. Usually caused by collisions; RxExcessSizeDisc—Packets received greater than 1536 octets and discarded due to excessive length. Usually caused by a faulty driver; RxSymbolError—Ethernet uses Manchester encoding to encode data as symbols before transmission over the physical media. The destination reverse encodes the symbols back into data. Some code symbols are invalid and are disallowed.

At 530, an IGMP report can be provided. An IGMP protocol adds a group number to a transmitted packet. Generally, only hosts in that IGMP group will receive the packet. The IGMP protocol prevents a multicast packet from acting like a broadcast (transmitted to all network hosts). The switch manages the task of forming a table of IGMP groups and hosts belonging to those groups. At 540, a MAC Address Report can be provided. All Ethernet equipment has a MAC address (hardware address). These can be displayed by selecting Diagnostics>MAC address report. A pool of MAC addresses are assigned to each Ethernet product manufacturer. At 550, an alarms status can be provided and configuration thereof will be described below.

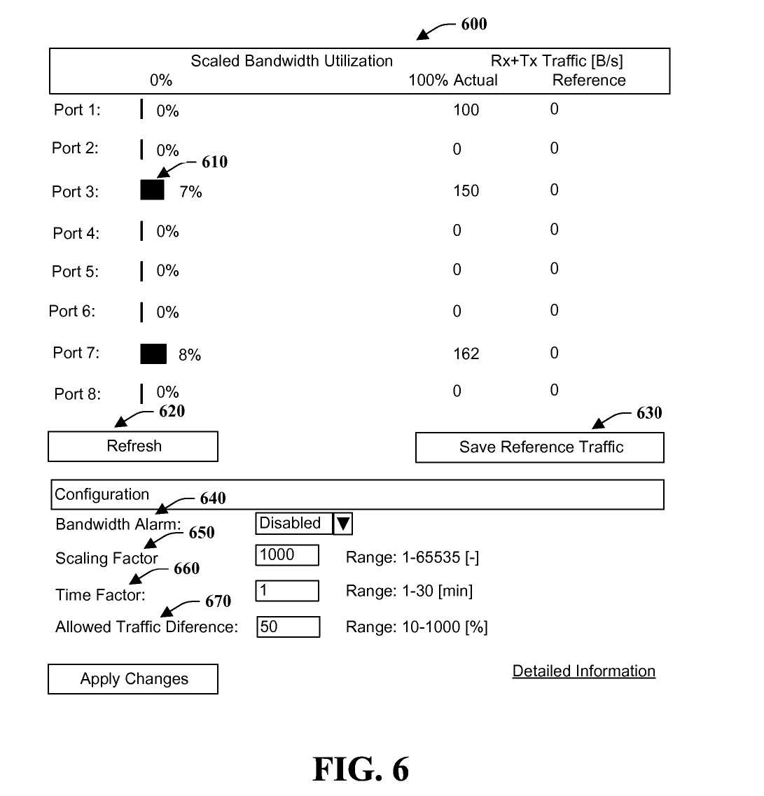

FIG. 6 illustrates an example alarm configuration interface 600 for a network switch. The interface 600 can be used to observe bandwidth on each port. For example, a bar 610 turn red (from green) when the bandwidth is out of range. At 620, a refresh selection is used to refresh the interface 600 with the latest information, where the interface can automatically refresh at the rate configured under Basic Configuration>Refresh Rate. At 630, a Save Traffic Reference is employed as a benchmark for the system network. Click this button 630 when the network is running as it should in production. The switch can calculate the difference between the reference point and the current levels of traffic for each port. If it varies to an alarm state, it can send an input to the PLC indicating the port number.

At 640, a Bandwidth Alarm configuration is disabled by default, and when enabled will calculate the difference between the reference point of the network and the current rate of traffic. If a variation, exceeding the allowed traffic difference, occurs it sends an input to the PLC indicating the port number that the bandwidth issue is occurring. At 650, a Scaling Factor configuration is provided. Most applications can have such a small amount of traffic that the bandwidth will only be a fraction of a percent. The scaling factor adjustment 650 allows a more visual representation of the traffic on each port. Scaling Factor can also be changed from the PLC using an input word. At 660, a Time Factor configuration relates to the length of time packets are counted to determine the bandwidth percentage for each port. At 670, an Allowed Traffic Difference includes the percentage that the current traffic level can vary in either direction, from the stored reference value, before an input is sent to the PLC.

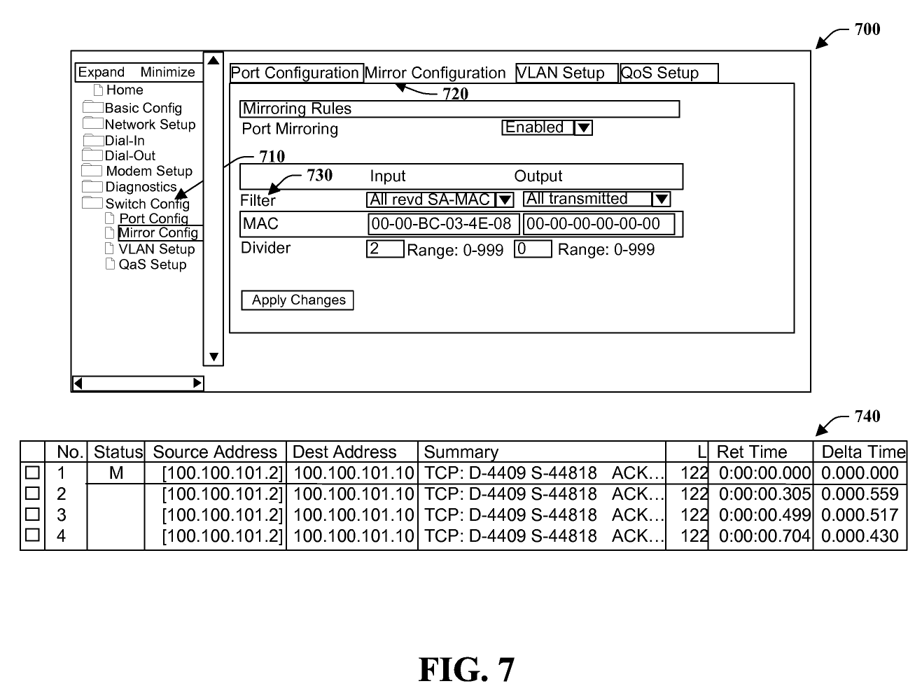

FIG. 7 illustrates an example interface 700 providing port configuration options. At 710, of the interface 700, a Port Configuration option 710 allows settings that are normally auto-configured to be manually configured. Some of these settings include: TX/RX—Controls communications on the selected port; Negotiation—Turn off auto-negotiation here if the port is to be manually configured; Rate—auto-negotiates 10 or 100 mbit/second based on the connected device, is manually selected if the negotiation parameter is changed to none; Duplex mode—auto-negotiates half or full based on the connected device. Is manually selected if the negotiation parameter is changed to none; Flow Control—prevents port buffers from over filling; Port Mirroring—allows traffic on one port, to be copied and sent (mirrored) to another port to allow an Ethernet sniffer to capture it; Quality of Service—when enabled, the switch can prioritize packet delivery to a certain port or MAC address; IGMP snooping when enabled, it sorts Multicast packets into groups and delivers them to the appropriate group.

At 720, Mirror Configuration options are provided. This section configures the rules or filters for port mirroring. Filters can be configured at 730 to capture packets from certain devices (MAC addresses). The filter can also capture packets with a certain destination address. At 740, when the Mirror configuration 720 is complete, packets can be displayed via Ethernet Sniffer Software.

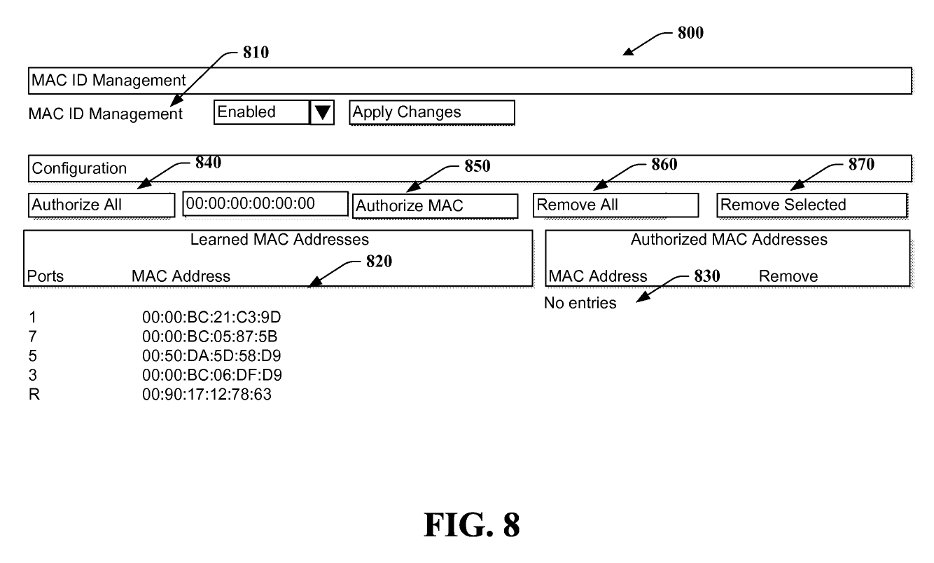

FIG. 8 illustrates an example interface 800 for MAC ID management that is employed to manage Ethernet devices that connect to the network and allows stricter control of the Ethernet network without the use of special Ethernet management software. At 810, a MAC ID Management configuration is used to enable this feature and send inputs to the PLC indicating unauthorized access to the network. At 820, a Learned MAC Addresses table lists the MAC IDs detected on the network by the switch. The port number and MAC ID are shown for each device detected on the network. This list is built automatically by the switch.

At 830 an Authorized MAC Addresses list indicates which MAC IDs are allowed on the network. This list is created by the user. When a new device comes online, this list is checked to determine if it is authorized. If the device is not authorized, an input is sent the PLC. At 840, an Authorize All Button moves all MAC IDs listed on the leaned MAC ID list 820 to the authorized MAC ID list. At 850, an Authorize MAC Button authorizes the MAC ID that is typed in the box to the left of this button. At 860, a Remove All Button removes all authorized MAC IDs from the authorized list. At 870, a Remove Selected configuration removes the selected MAC ID from the authorized list.

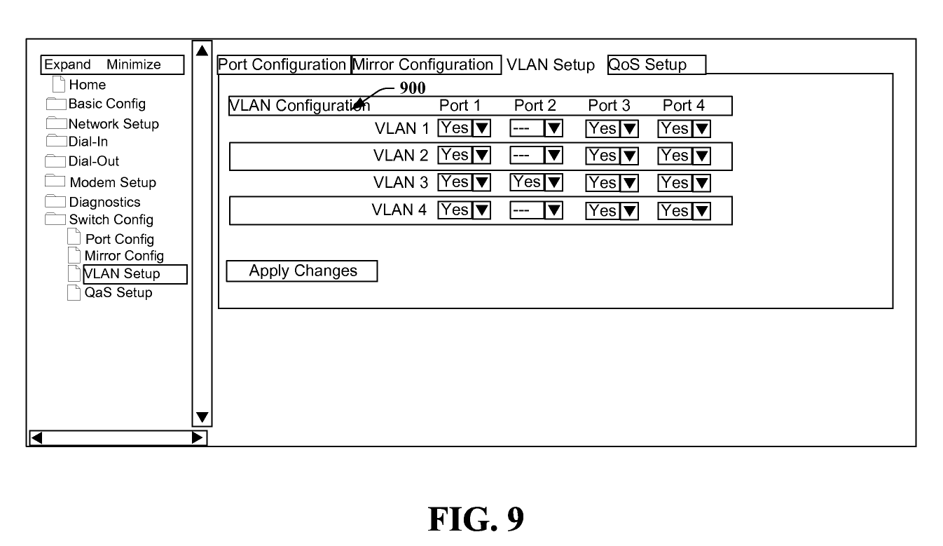

FIG. 9 illustrates an example VLAN interface 900. The VLAN feature is employed when network bandwidth becomes critical. Thus, VLAN can be used to eliminate traffic caused by Multicast and Broadcast Ethernet traffic. With this feature, the switch ports can be partitioned into different private domains. For each received packet the, switch resolves the destination address and determines the appropriate port. The VLAN configuration 900 is then checked to see if the destination address is configured to receive traffic from the source port.

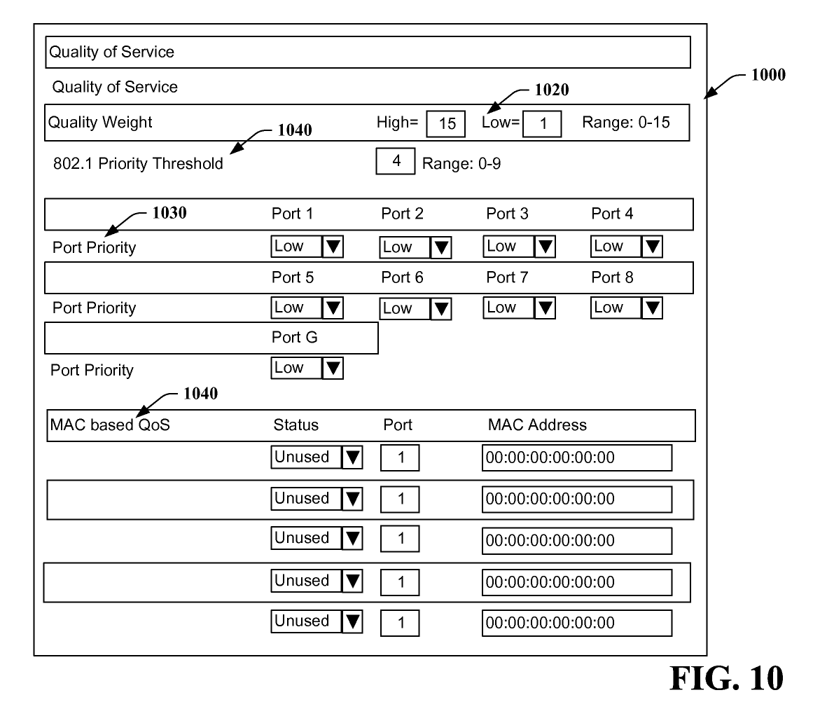

FIG. 10 illustrates an example Quality of Service interface 1000. Quality of service (QoS) allows the classification of Ethernet traffic into “high” and “low” priority queues. High priority packets can be forwarded to their destination address before a low priority packet. Packets can be classified as high or low by: MAC address, 802.1p priority tag, and or port ID, for example. Port priority can be set at 1010. When changed to High, the incoming traffic for that port is considered High Priority. At 1020, a High/Low Quality weight establishes an algorithm for switching between High and low priority Queues. The default value of 15/1 will send 15 blocks of High priority traffic then send 1 block of low priority traffic. Incoming packets can be cross referenced with a MAC based QoS list at 1030, and put into a high priority queue if the destination address is on the list. Also, each incoming packet can be examined for a valid 802.1p priority tag. If present, the packet can be put in the high priority queue if the priority tag exceeds a QoS Priority Threshold at 1040.

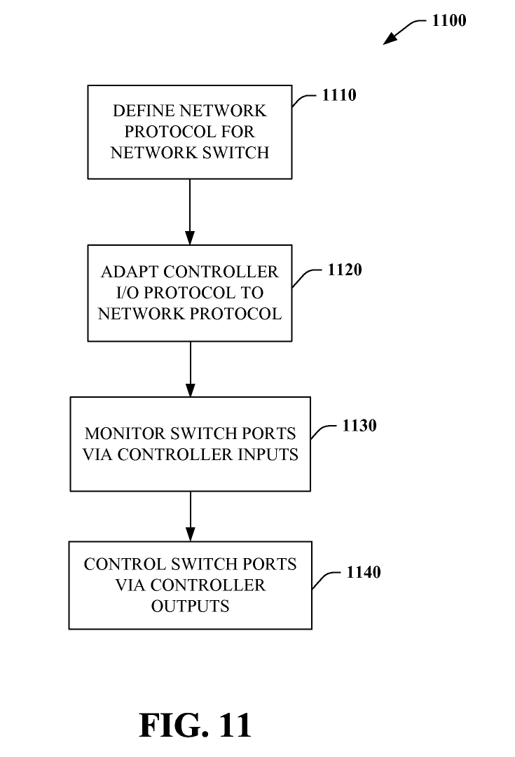

FIG. 11 illustrates a network control process 1100 for an industrial automation system. While, for purposes of simplicity of explanation, the methodology is shown and described as a series of acts, it is to be understood and appreciated that the methodology is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as described herein.

Proceeding to 1110 of FIG. 11, a network protocol is defined for a network switch. This can include substantially any type of protocol that enables devices external or local to the control system to have network access to the control system via the switch. In a common example, the network protocol includes Ethernet but other network protocols are possible. At 1120, a controller I/O protocol is adapted to the network protocol defined above at 1110. In essence, the control I/O protocol is transported over the network protocol to a controller or other module having I/O capabilities, where in addition to the network communications, the controller can also communicate to the switch via controller input and output data table locations. Thus, the switch ports appear as an I/O module to the controller (similar to I/O in the rack with the controller) even though the inputs and outputs are transported within the confines of the network protocol defined at 1110.

In one specific example, in a four port switch example, the controller may be connected over the Ethernet to one of the four respective ports. In the controller input data table, status is provided regarding whether or not devices have accessed the respective ports. For instance, a MAC ID configuration can be provided that authorizes one or more MAC ID's to access the other three ports on the switch. If a device were to access the switch, and did not utilize an authorized MAC ID, an input bit could be set indicating an unauthorized access was attempted on one or more of the ports. Proceeding to 1140, of FIG. 11, outputs from the controller can be set to turn off (or turn on) a respective port. Thus, in the example above, if an unauthorized MAC ID were detected at port 3 for example, and the controller were connected to port 1, the controller could send an output command via the controller data table that would be transmitted in accordance with the network protocol on port 1, where the command can be employed by the switch to turn off or disable the communications at port 3.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A network component for an industrial automation system, comprising:
a network infrastructure device that includes one or more ports; and
an interface component that enables the network infrastructure device to function as at least one input or at least one output to a controller.

2. The system of claim 1, further comprising a module to read the inputs or write to the outputs.

3. The system of claim 2, the module is a programmable controller.

4. The system of claim 1, the interface component provides a public network protocol for a controller input/output protocol.

5. The system of claim 4, the public network protocol is an Ethernet protocol.

6. The system of claim 4, the controller input/output protocol is accessed from a controller data table location.

7. The system of claim 4, the interface component operates as an Ethernet adapter that provides I/O connection capability over the Ethernet.

8. The system of claim 1, the inputs are employed to read a connection status for the ports.

9. The system of claim 8, the connection status is related to a MAC ID status.

10. The system of claim 9, the MAC ID status is related to access of at least one port.

11. The system of claim 10, further comprising a configuration component to set an authorized or unauthorized MAC ID for a port.

12. The system of claim 1, the outputs are employed to enable or disable the ports.

13. The system of claim 1, the inputs are employed to provide diagnostics for the network switch.

14. The system of claim 13, the diagnostics provide status from at least one alarm condition.

15. The system of claim 14, the alarm condition is associated with at least one of a bandwidth alarm, a scaling factor, a time factor, and an allowed traffic difference.

16. The system of claim 15, the scaling factor is associated with a scaled bandwidth utilization component.

17. The system of claim 13, the diagnostics include one or more transmit counters, one or more receive counters, an IGMP report, and a MAC address report.

18. The system of claim 1, further comprising a component to mirror network data from the ports.

19. The system of claim 1, further comprising a network sniffer to monitor network data from a port.

20. The system of claim 1, further comprising a filter component that is applied to data associated with the port.

21. The system of claim 1, further comprising a capture component to log data generated at the ports.

22. The system of claim 1, further comprising a component to monitor and automatically detect network addresses.

23. The system of claim 22, further comprising a component to automatically authorize detected network addresses.

24. The system of claim 1, further comprising a component to partition ports into separate private domains.

25. The system of claim 1, the network switch further comprising a quality of service (QoS) adjustment.

26. The system of claim 25, the QoS adjustment further comprising at least one of a quality weight, a port priority setting, a priority threshold setting, and a network priority setting.

27. A computer readable medium having a data structure stored thereon to facilitate remote network interaction in an industrial automation environment, comprising:
a first data field to specify a network protocol associated with at least one public network;
a second data field to specify an industrial controller protocol that is associated with an input status or an output command; and
a third data field that transports the controller protocol within the network protocol.

28. The computer readable medium of claim 27, the network protocol is an Ethernet protocol.

29. The computer readable medium of claim 27, the input status is associated with a MAC ID status field.

30. The computer readable medium of claim 27, the output command is sent to a controller output data table and employed to enable or disable a network port associated with the network protocol.

31. A method to control access to industrial control components, comprising:
providing a plurality of switches to facilitate access to a network;
adapting a controller I/O protocol to a network protocol, the controller I/O protocol and the network protocol employed by the switches; and
controlling an on or off state of the switches via the controller I/O protocol.

32. The method of claim 31, further comprising providing network status via the controller I/O protocol.

33. The method of claim 32, further comprising providing network diagnostics via the controller I/O protocol.

34. The method of claim 32, further comprising controlling quality of network service via the controller I/O protocol.

35. The method of claim 32, further comprising generating a MAC ID status for the network status.

36. The method of claim 31, further comprising configuring the plurality of switch via the network protocol.

37. A modular system for an industrial control environment, comprising:
means for generating at least one network protocol;
means for transporting at least one controller I/O protocol within the network protocol; and
means for switching a network port based in part on commands received from the controller I/O protocol.
